(19) United States
(12) Patent Application Publication
(10) Pub. No.: US 2025/0269661 A1
(43) Pub. Date: Aug. 28, 2025

(54) LIQUID EJECTING APPARATUS AND HEAD INSPECTION METHOD

(71) Applicant: BROTHER KOGYO KABUSHIKI KAISHA, Nagoya (JP)

(72) Inventors: Hiroshi KATAYAMA, Anjo (JP); Rikuto MITOKA, Nagoya (JP); Motoki YAMADA, Nagoya (JP); Mikio OGAWA, Nagoya (JP)

(73) Assignee: BROTHER KOGYO KABUSHIKI KAISHA, Nagoya (JP)

(21) Appl. No.: 19/205,090

(22) Filed: May 12, 2025

Related U.S. Application Data
(63) Continuation of application No. PCT/JP2023/043078, filed on Dec. 1, 2023.

(30) Foreign Application Priority Data
Dec. 6, 2022 (JP) 2022-195199

(51) Int. Cl. B41J 2/19; B41J 2/14; B41J 2/165; B41J 2/175; B41J 2/18

(52) U.S. Cl. CPC B41J 2/19; B41J 2/16505; B41J 2/16552; B41J 2/17596; B41J 2/18; B41J 2002/14419; B41J 2002/16558

(57) ABSTRACT

A liquid ejecting apparatus including: a tank; a head including a nozzle, a head channel, a supply manifold, and a return manifold; a liquid supply channel; a liquid return channel; a positive pressure pump; a negative pressure pump; and a controller configured to execute a first initial introduction process depending on acceptance of a first command indicating an initial introduction of a first liquid. The first initial introduction process includes: a first step of driving the positive pressure pump in a state that the negative pressure pump is stopped; and a second step of driving the positive pressure pump and the negative pressure pump after the first step. Surface tension of the first liquid stored in the tank in the first initial introduction process is 30 mN/m or greater.

### REFERENCE TO RELATED APPLICATIONS

This application is a Continuation Application of International Application No. PCT/JP2023/043078 claiming the conventional priority of Japanese patent Application No. 2022-195199 filed on Dec. 6, 2022. The entire content of Japanese patent Application No. 2022-195199 and the entire content of International Application No. PCT/JP2023/043078 are incorporated herein by reference.

### BACKGROUND ART

As a liquid ejecting apparatus configured to eject an ink from a head, the liquid ejecting apparatus including a liquid ejecting head having an inflow channel and an outflow channel is known. Positive pressure is applied to the inflow channel by a positive pressure pump. Negative pressure is applied to the outflow channel by a negative pressure pump. The positive pressure pump and the negative pressure pump are driven to circulate an ink between the ejecting head and an ink tank.

### SUMMARY

After assembly of a liquid ejecting apparatus in a factory for example, the liquid ejecting apparatus is caused to eject an inspection liquid from an ejecting head, for inspection. A composition of the inspection liquid is different from a composition of an ink. In a case where a surface tension of the inspection liquid is greater than a surface tension of the ink, air bubbles are likely to be generated in the inspection liquid. In a case where a positive pressure pump and a negative pressure pump are driven to introduce the inspection liquid from an ink tank to an ejecting head, the air bubbles will be generated in the inspection liquid by the air having entered the ejecting head through nozzles. The air bubbles generated in the inspection liquid is likely to adhere to the inner surface of the ejecting head, and even if the inspection liquid is circulated between the ink tank and the ejecting head, the air bubbles may not be discharged from the ejecting head. If the air bubbles exist in the ejecting head, the inspection liquid may not be properly ejected from the nozzle of the ejecting head.

The present disclosure has been made in view of the above described circumstances, and an object of the present disclosure is to provide a means by which an air bubble is less likely to remain in a head, in a case where a liquid having high surface tension is introduced into the head from a tank.

A first aspect of the present disclosure is a liquid ejecting apparatus including: a tank configured to store a liquid;
a head including:
a nozzle;
   a head channel communicating with the nozzle;
   a supply manifold communicating with the head channel; and
   a return manifold communicating with the head channel;
a liquid supply channel connecting the tank and the supply manifold;
a liquid return channel connecting the tank and the return manifold;
a positive pressure pump configured to apply positive pressure to supply the liquid from the tank to the head through the liquid supply channel;
a negative pressure pump configured to apply negative pressure to discharge the liquid from the head to the tank through the liquid return channel; and
a controller configured to execute a first initial introduction process depending on acceptance of a first command indicating an initial introduction of a first liquid.

The first initial introduction process includes:
a first step of driving the positive pressure pump in a state that the negative pressure pump is stopped; and
a second step of driving the positive pressure pump and the negative pressure pump after the first step.

Surface tension of the first liquid stored in the tank in the first initial introduction process is 30 mN/m or greater.

In a case where an air bubble is generated in the first liquid having the surface tension of 30 mN/m or greater, the air bubble adheres to an inner surface of the head channel or the return manifold, and even in a case where the first liquid flows in the head channel or the return manifold, the air bubble adhering to the inner surface may not flow to the tank. In the first step, the negative pressure pump is stopped and the positive pressure pump is driven. Thus, the first liquid flows in order from the liquid supply channel to the supply manifold, the head channel, the return manifold, and the liquid return channel, and gas will be discharged to the tank through the liquid return channel with the flow of the first liquid. Since the negative pressure pump is stopped in the first step, gas does not enter the head channel from the nozzle and the air bubble is less likely to be generated in the head channel. The head channel, the return manifold, and the liquid return channel are filled with the first liquid in the first step, and then the positive pressure pump and the negative pressure pump are driven in the second step. Thus, the first liquid is circulated between the tank and the head.

A second aspect of the present disclosure is a head inspection method in which a head is inspected by:
supplying an inspection liquid, having surface tension greater than surface tension of an ink to be ejected from a nozzle of the head in image recording, from a tank storing the inspection liquid to a head channel communicating with the nozzle, a supply manifold communicating with the head channel, and a return manifold communicating with the head channel through a liquid supply channel;
returning the inspection liquid to the tank through a liquid return channel from the return manifold; and
ejecting the inspection liquid from the head.

The head inspection method includes:
a first step of applying a positive pressure to supply the inspection liquid from the tank to the head through the liquid supply channel by driving a positive pressure pump in a state that a negative pressure pump is stopped; and
a second step of applying a negative pressure to discharge the liquid from the head to the tank through the liquid return channel and the positive pressure, by driving the positive pressure pump and the negative pressure pump, after the first step.

According to the present disclosure, a bubble is less likely to remain in a head, in a case where a liquid having high surface tension is introduced into the head from a tank.

### BRIEF DESCRIPTION OF DRAWINGS

FIG. 1 is an external perspective view of an image recording apparatus 100.

FIG. 2 is a cross-sectional view depicting the cross section at the II-II of FIG. 1.

FIG. 3 is a schematic view depicting a channel between an ink sub-tank 47 and a head module 49.

FIG. 4 is a block diagram depicting a controller 130.

FIG. 5 is a flowchart of an initial introduction of an inspection liquid.

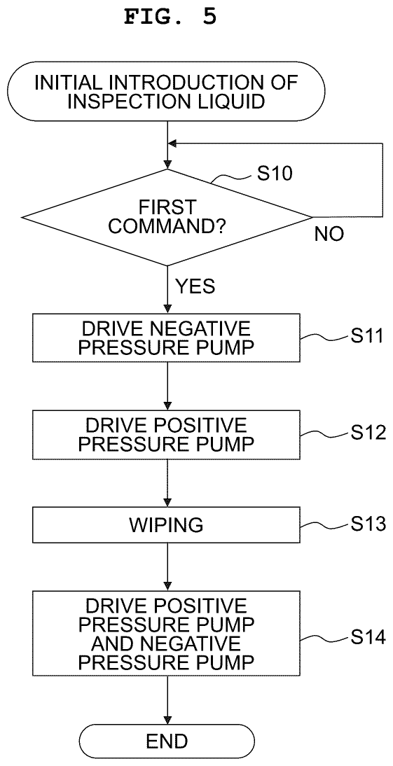

FIG. 6 is a flowchart of an initial introduction of an ink.

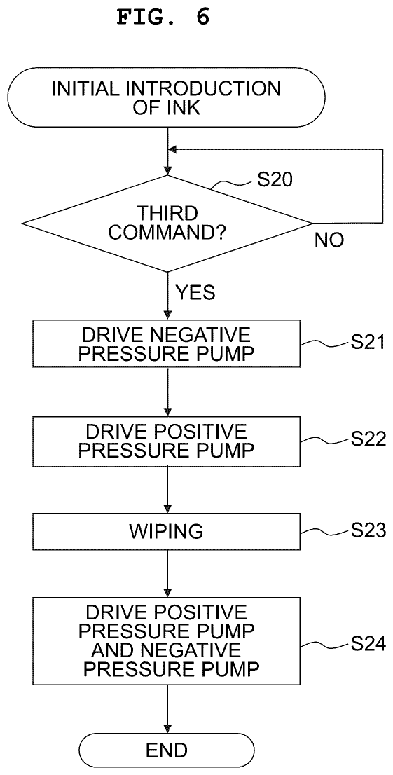

### DESCRIPTION

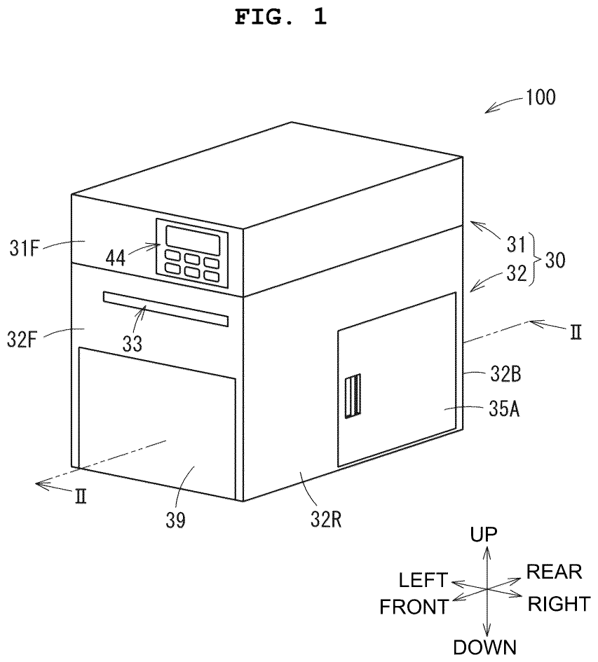

Embodiment of the present disclosure will be described below. The embodiment is merely one aspect of the present disclosure, and the aspect can be modified to the extent that the gist of the present disclosure is not changed. In the following description, the forward advance from a starting point of an arrow to an ending point of the arrow is expressed as orientation, and the forward and backward advances on the line connecting the starting point and the ending point of the arrow is expressed as direction. In the following description, the up-down direction is defined based on the state in which the image recording apparatus 100 is installed in a usable state (the state in FIG. 1), the front-rear direction is defined such that the side where a discharging port 33 is disposed is defined as the front-side (front), and the left-right direction is defined seeing the image recording device 100 from the front-side (front).

### (External Configuration of Image Recording Apparatus 100)

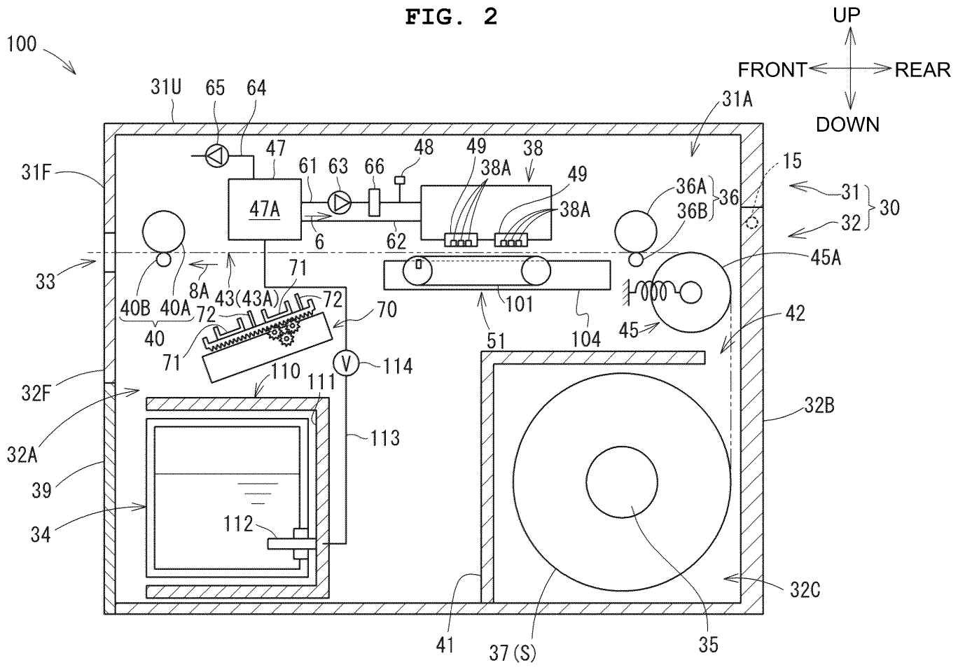

The image recording apparatus 100 depicted in FIG. 1 records an image on a sheet S extending from a roll body 37 (see FIG. 2) in accordance with the inkjet recording system. The image recording apparatus 100 is an example of a liquid ejecting apparatus.

As depicted in FIG. 1, the image recording device 100 includes a housing 30. The housing 30 includes an upper housing 31 and a lower housing 32. The upper housing 31 and a lower housing 32 have generally rectangular shape as a whole and have a size capable of being placed on a tabletop. In other words, the image recording apparatus 100 is suitable for use on a tabletop. Of course, the image recording apparatus 100 may be used while being placed on a floor or a rack. A frame may be disposed in the housing 30 to support each component as appropriate.

As depicted in FIG. 2, an upper housing 31 is rotatably supported by a lower housing 32. The upper housing 31 can rotate between the closed position depicted in FIG. 2 and the open position about the rotation axis 15 which is disposed at the rear lower end part and extends in the left-right direction. The configuration in which the upper housing 31 rotates is not limited to the configuration in which the rotation is realized by the rotation axis 15, but may also be a configuration in which the rotation is realized by, for example, hinges etc.

As depicted in FIG. 2, in a case where the upper housing 31 is in the closed position, an inner space 31A of the upper housing 31 and an inner space 32A of the lower housing 32 are shielded from the outside. In a case where the upper housing 31 is in the open position, the inner space 31A of the upper housing 31 and the inner space 32A of the lower housing 32 are exposed to the outside.

As depicted in FIG. 1, a slit-like discharge port 33 elongated in the left-right direction is disposed on a front surface 32F of the lower hosing 32. A sheet S (see FIG. 2) on which an image has been recorded is to be discharged from the discharge port 33.

An operation panel 44 is disposed on the front surface 31F of the upper housing 31. A user performs input on the operation panel 44 to cause the image recording apparatus 100 to operate, and to finalize various settings.

As depicted in FIG. 1, a right cover 35A is located on a right surface 32R of the lower housing 32. By opening and closing the right cover 35A, a holder 35 etc. (see FIG. 2) located in a sheet accommodation space 32C are exposed to the outside or shielded from the outside.

As depicted in FIG. 1, a front cover 39 is located on the front surface 32F of the lower housing 32. The front cover 39 can be opened in a manner that the upper end-side of the front cover 39 falls frontward about a rotation axis (not depicted) which extends along the left-right direction and which is disposed at a position near the lower end of the front cover 39. By opening and closing of the front cover 39, the installation case 110 etc. (see FIG. 2) located in the inner space 32A of the lower housing 32 are exposed to the outside or shielded from the outside.

### (Internal Configuration of Image Recording Apparatus 100)

As depicted in FIG. 2, a holder 35, a tensioner 45, a conveying roller pair 36, a conveying roller pair 40, a head unit 38, a platen 51, an ink tank 34, the installation case 110, an ink sub-tank 47, a maintenance unit 70, etc. are disposed in the inner spaces 31A, 32A. Although not depicted, a fixing unit, an image sensor, a cutter, etc. may be located in the inner space 32A. The head unit 38 is an example of a head. The ink sub-tank 47 is an example of a tank.

A partition wall 41 is disposed in the inner space 32A. The partition wall 41 divides the rear lower part of the inner space 32A to demarcate the sheet accommodation space 32C. The sheet accommodation space 32C is a space which is surrounded by the partition wall 41 and the lower housing 32, and which is isolated from the head unit 38, etc.

The tensioner 45 is located above the partition wall 41 at the rear part of the inner space 32A. The tensioner 45 has a periphery surface 45A facing outward from the lower housing 32. The periphery surface 45A has a size larger than the maximum width of the sheet in the left-right direction and has a shape symmetrical to each other with respect to the paper feed center (the center of the sheet S in the left-right direction). The upper end of the periphery surface 45A is generally at the same position as the nip position of the conveying roller pair 36 in the up-down direction.

The sheet S drawn out from the roll body 37 is hung on and abuts the periphery surface 45A. The sheet S curves forward along the periphery surface 45A, extends in the conveying orientation 8A, and is guided by the conveying roller pair 36. The conveying orientation 8A is forward orientation along the front-rear direction. The tensioner 45 applies tension to the sheet S using a known technique.

The conveying roller pair 36 is located in front of the tensioner 45. The conveying roller pair 36 includes a conveying roller 36B and a pinch roller 36A. The nip positions of the conveying roller 36B and the pinch roller 36A is generally the same as the upper end of the periphery surface 45A in the up-down direction.

The conveying roller pair 40 is located in front of the conveying roller pair 36. The conveying roller pair 40 includes a conveying roller 40B and a pinch roller 40A. The nip positions of the conveying roller 40B and the pinch roller 40A is generally the same as the upper end of the periphery surface 45A in the up-down direction.

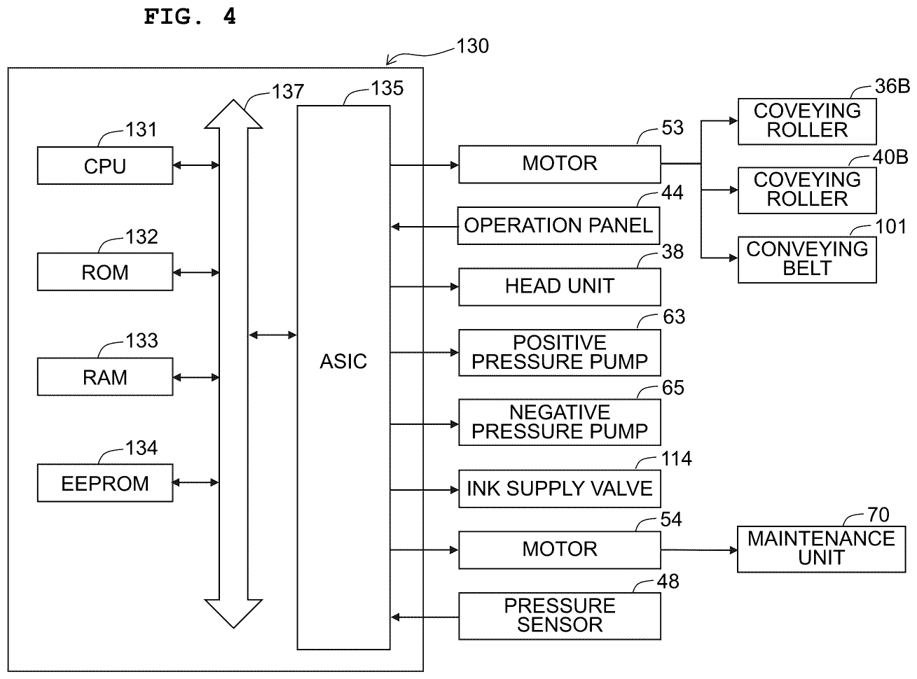

The conveying rollers 36B, 40B rotate with the driving force transmitted from the motor 53 (see FIG. 4). The conveying roller pair 36 feeds the sheet S in the conveying orientation 8A by rotating while nipping the sheet S extending from the tensioner 45 in the conveying orientation 8A. The conveying roller pair 40 feeds the sheet S in the conveying orientation 8A by rotating while nipping the sheet S fed from the conveying roller pair 36. By the rotation of the conveying roller pairs 36, 40, the sheet S is drawn out from the sheet accommodation space 32C through the gap 42 toward the tensioner 45.

As depicted in FIG. 2, a conveying route 43 extending from the upper end of the periphery surface 45A to the discharge port 33 is defined in the inner space 32A. The conveying route 43 extends almost linearly along the conveying orientation 8A and is a space through which the sheet S can pass. The conveying route 43 extends along a conveying surface 43A which extends in the conveying orientation 8A and in the left-right direction, and which is long in the conveying orientation 8A. In FIG. 2, the conveying surface 43A is represented by a two-dot chain line indicating the conveying route 43. The conveying route 43 is demarcated by a guide member (not depicted), the head unit 38, and the platen 51, etc., which are located separately in the up-down direction.

The head unit 38 is located above the conveying route 43 and downstream in the conveying orientation 8A of the conveying roller pair 36. The head unit 38 has head modules 49 each having a plurality of nozzles 38A. The head module 49 is another example of a head.

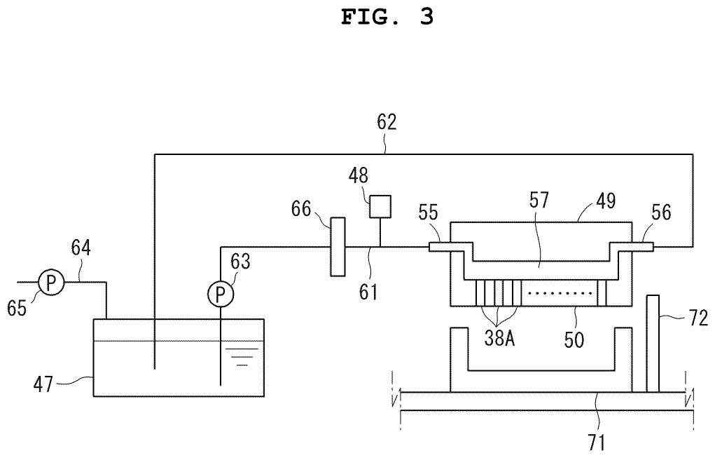

As depicted in FIG. 3, the head module 49 has a supply manifold 55, a return manifold 56, a head channel 57, and nozzles 38A. The supply manifold 55 is a space continuous with a liquid supply channel 61. The return manifold 56 is a space continuous with a liquid return channel 62. The head channel 57 is a channel continuous with the supply manifold 55 and the return manifold 56. The nozzles 38A are located in the head channel 57. The nozzles 38A open on a nozzle surface 50, which is the lower surface of head module 49.

An ink supplied from the ink sub-tank 47 to the supply manifold 55 through the liquid supply channel 61 flows to the return manifold 56 through the head channel 57. The ink flows from the return manifold 56 to the ink sub-tank 47 through the liquid return channel 62. Thus, a circulation channel is formed between the ink sub-tank 47 and the nozzles 38A by the liquid supply channel 61, the supply manifold 55, the head channel 57, the return manifold 56, and the liquid return channel 62. Although not depicted in FIG. 3, a piezoelectric element is disposed corresponding to the nozzle 38A, and in a case where the piezoelectric element is driven, an ink droplet is ejected downward from the nozzle 38A toward the conveying belt 101. As a result, an image is recorded on the sheet S. The ink is an example of a second liquid.

The platen 51 is located below the conveying route 43 and downstream in the conveying orientation 8A of the conveying roller pair 36. The platen 51 is located below the head unit 38 and faces the head unit 38. The platen 51 has a conveying belt 101 and a support part 104. The conveying belt 101 supports the sheet S that is conveyed by the conveying roller pair 36 in the conveying orientation 8A and is positioned directly below the head unit 38. The conveying belt 101 conveys the sheet S supported by the conveying belt 101 in the conveying orientation 8A.

The installation case 110 is located near the front and bottom ends of the lower housing 32 and has a box-shape with an opening facing forward. The ink tank 34 is to be inserted rearwardly into the installation case 110. An ink needle 112 extending forward is located on an end surface 111, of the installation case 110, facing rearwardly. The front end of the ink needle 112 is open and the rear end of the ink needle 112 is connected to an ink tube 113. The ink tube 113 connects the inner space of the ink needle 112 and the inner space 47A of the ink sub-tank 47 so that an ink can flow between the inner space of the ink needle 112 and the inner space 47A. In a case where the ink tank 34 has been installed in the installation case 110, the ink needle 112 has been inserted into the outflow port (not depicted) of the ink tank 34. As a result, an ink stored in the ink tank 34 is supplied to the ink sub-tank 47 through the ink needle 112 and the ink tube 113. An ink supply valve 114 capable of opening and closing the channel of the ink tube 113 is located in the ink tube 113. The opening and closing of the ink supply valve 114 is controlled by a controller 130.

The ink tank 34 stores the ink. Details of the ink will be described below. In a case where the ink has been consumed, the ink tank 34 will be removed from the installation case 110 and will be replaced with a new ink tank 34 storing the ink.

The ink sub-tank 47 is located above the ink tank 34. The ink sub-tank 47 stores the ink supplied from the ink tank 34. The liquid supply channel 61, the liquid return channel 62, and an atmosphere communicating channel 64 are connected to the ink sub-tank 47. The liquid supply channel 61 and the liquid return channel 62 connect the ink sub-tank 47 and the head unit 38 so that the ink can flow between the ink sub-tank 47 and the head unit 38. One end of the atmosphere communicating channel 64 opens to the upper part of the inner space 47A of the ink sub-tank 47, and the other end of the atmosphere communicating channel 64 opens to the inner space 31A of the upper housing 31.

The positive pressure pump 63 is disposed in the liquid supply channel 61. The positive pressure pump 63 applies pressure to the ink in the orientation toward the head unit 38 in the liquid supply channel 61. The positive pressure pump 63 can be, for example, a diaphragm pump. The drive of the positive pressure pump 63 is controlled by the controller 130.

A pressure sensor 48 is disposed in the liquid supply channel 61. The pressure sensor 48 detects the air pressure in the liquid supply channel 61 and outputs a detection signal to the controller 130.

A negative pressure pump 65 is disposed in the atmosphere communicating channel 64. The negative pressure pump 65 reduces the pressure in the inner space 47A of the ink sub-tank 47 by sucking the air from the inner space 47A of the ink sub-tank 47. The negative pressure pump 65 can be, for example, a diaphragm pump. The air sucked by the negative pressure pump 65 is released to the atmosphere through the atmosphere communication channel 64. The drive of the negative pressure pump 65 is controlled by the controller 130.

A filter 66 is disposed in the liquid supply channel 61. The filter 66 is located between the positive pressure pump 63 and the head unit 38. In FIG. 2, the channel shape of the liquid supply channel 61 and the arrangement of the filter 66 are depicted in a simplified manner. The filter 66 has a configuration in which, a mesh-type filter member with a plurality of holes each having a predetermined inner diameter for example, is housed in the inner space of a housing having an outflow port and an inflow port. In a case where the ink that flown into the inner space of the housing from the inflow port passes through the filter member, solids contained in the ink that are larger than the inner diameter of the holes of the filter member are captured by the filter member. This reduces flowing of the solids contained in the ink into the head unit 38.

A maintenance unit 70 is a unit for performing maintenance of the head unit 38. As depicted in FIG. 2, the maintenance unit 70 is configured to be movable and is moved to a position directly below the head unit 38 in a case where maintenance of the head unit 38 is performed. The maintenance unit 70 moves to the position directly below the head unit 38 and performs each processing operation, based on the transmission of the driving of the motor 54 (see FIG. 4). The maintenance unit 70 includes a cap 71 and a wiper 72. Although not depicted in each drawing, the inner space of the cap 71 is connected to a cleaning liquid tank and a waste liquid tank. The wiper 72 is a water-absorbing body that is to be impregnated with a cleaning liquid and has a flat plate shape. The wiper 72 may has a blade shape made of a rubber, or the like.

The maintenance of the head unit 38 includes a purging process, a cap cleaning process, and a wiping process, etc. The purging process is a process of covering the nozzle surface 50, of the head module 49, on which the nozzles 38A open with the cap 71 of the maintenance unit 70, and then sucks the ink from the nozzles 38A by using a suction pump. The cap cleaning process is a process of cleaning the nozzle surface 50 of the head module 49 with a cleaning liquid fed into the inner space of the cap 71 in a state that the nozzle surface 50 of the head module 49 is covered with the cap 71. The wiping process is a process of wiping the nozzle surface 50 of the head module 49 by the movement of the wiper 72 of the maintenance unit 70 relative to the head module 49.

### (Controller 130)

As depicted in FIG. 4, the controller 130 includes a CPU 131, a ROM 132, a RAM 133, an EEPROM 134, and an ASIC 135, which are connected to each other by an internal bus 137. The ROM 132 stores program(s), etc. for controlling various operations of the CPU131. The RAM 133 is used as a storage area to temporarily record data, signals, etc. used in a case where the CPU131 executes the above program(s), or as a work area for data processing. The EEPROM 134 stores a setting, a flag, etc. which should be stored even after the power is turned off.

The motors 53, 54, the positive pressure pump 63, the negative pressure pump 65, and the ink supply valve 114 are connected to the ASIC 135. Those components are connected to the ASIC 135 via a driving circuit for driving them as necessary. The ASIC 135 generates driving signals for rotating the motors 53, 54, and controls the motors 53, 54 with the driving signals. The controller 130 controls the drive of the positive pressure pump 63 and the negative pressure pump 65. The controller 130 controls the opening and closing of the ink supply valve 114.

The operation panel 44 and the head unit 38 are connected to the ASIC 135. The operation panel 44 outputs operation signals corresponding to an operation by a user to the controller 130. The operation panel 44 may, for example, have pushbutton(s) or a touch sensor overlapped with a display. The controller 130 controls the power supply to the piezoelectric elements of the head unit 38 to selectively eject ink droplets from the plurality of nozzles 38A.

### (Ink)

The ink includes resin particles, a color material, an organic solvent, a surfactant, and water. The ink is a water-based ink in which the resin particles, the color material, and the organic solvent are dissolved in the water. The ink is an example of a second liquid.

The ink has wettability to a hydrophobic recording medium such as a coated paper, a plastic, a film, an OHP sheets, etc., but is not limited to those media. The ink may be suitable for image recording on a medium, other than the hydrophobic recording medium, such as a plain paper, a glossy paper, and a matte paper, for example. The “coated paper” means, for example, a paper obtained by applying a coating agent on a plain paper including a pulp as a main component, such as a high-grade printing paper, an intermediate-grade printing paper, etc., to improve smoothness, whiteness, glossiness, etc. Specific examples of the “coated paper” are a high-grade coated paper and an intermediate grade coated paper, etc.

Surface tension of the ink may be less than 28 mN/m, less than 27 mN/m, or less than 26 mN/m. The surface tension of the ink can be measured, for example, by the Wilhelmy method or the ring method.

### (Inspection Liquid)

After manufacturing and before shipment of the image recording apparatus 100, an inspection liquid is used to inspect the operation of the head module 49. The inspection of the head module 49 is performed, for example, for determining whether each nozzle 38A of the head module 49 accurately ejects a liquid.

The inspection liquid contains a red dye, glycerin, a penetrant, and water. The inspection liquid is a liquid to be introduced into the head module 49 for the purpose of printing inspection in a finished product inspection process. Specifically, the inspection liquid is used for the purpose of, for example, confirming that all nozzles 38A of the head module 49 are capable of performing ejecting. The inspection liquid is an example of the first liquid.

The surface tension of the inspection liquid may be 28 mN/m or greater, 29 mN/m or greater, or 30 mN/m or greater. The surface tension of the ink can be measured by the same method as the method for measuring the surface tension of the ink described above.

### (Initial Introduction of Inspection Liquid (First Initial Introduction Process))

After the manufacturing and before the shipment of the image recording apparatus 100, the inspection liquid is initially introduced into the head module 49 for inspecting the operation of the head module 49. The supply manifold 55, the return manifold 56, the head channel 57, and the nozzles 38A of the head module 49 may be in a state where no liquid exists, or a preservation liquid has been partially introduced to prevent drying. Even in a state that the preservation liquid has been introduced, no meniscuses of liquid are formed at the nozzles 38A on the nozzle surface 50. The maintenance unit 70 is located below the head module 49.

The ink tank 34 storing the inspection liquid will be installed in the installation case 110 for the purpose of performing the inspection. Thereafter, a first command is sent to the controller 130 in a case where the initial introduction of the inspection liquid is selected and execution is entered on the operation panel 44.

In response to the acceptance of the first command (step S10), the controller 130 opens the ink supply valve 114 and drives the negative pressure pump 65 (step S11). This depressurizes the gas layer in the ink sub-tank 47, and the pressure difference between the pressure in the ink sub-tank 47 and the pressure in the ink tank 34 causes the inspection liquid in the ink tank 34 to be supplied to the ink sub-tank 47 through the ink tube 113. By the negative pressure pump 65 being driven for a certain period of time, a predetermined amount of the inspection liquid is supplied from the ink tank 34 to the ink sub-tank 47. In a case where the supply of the inspection liquid has been completed, the ink supply valve 114 will be closed.

Next, the controller 130 drives the positive pressure pump 63 to generate a first pressure value (step S12). For example, the positive pressure applied to the liquid supply channel 61 by the positive pressure pump 63 is adjusted by controlling the number of reciprocation per unit time and/or the distance of reciprocation of the diaphragm of the diaphragm pump according to the pressure value detected by the pressure sensor 48. At this time, the controller 130 does not drive the negative pressure pump 65. The step S12 is an example of the first step.

The inspection liquid is introduced from the ink tank 34 to the ink sub-tank 47 by the drive of the positive pressure pump 63. Further, the inspection liquid is introduced from the ink sub-tank 47 to the supply manifold 55, the head channel 57, the return manifold 56, and the liquid return channel 62 through the liquid supply channel 61. With the introduction of the inspection liquid, gas in the supply manifold 55, the head channel 57, the return manifold 56, and the liquid return channel 62 is discharged through the liquid return channel 62 to the ink sub-tank 47.

Since the negative pressure pump 65 is not driven, no gas enters the head channel 57 and/or the return manifold 56 through the nozzles 38A, even in a state that no liquid exists in the nozzles 38A or no meniscuses are formed. Therefore, in a case where the head channel 57 is filled with the inspection liquid, the inspection liquid flows from the head channel 57 to the nozzles 38A. If the meniscuses of the inspection liquid are not formed at the nozzles 38A, the inspection liquid flows out of the nozzles 38A, but the inspection liquid flown out of the nozzles 38A will be stored in the cap 71.

Since no gas enters the head channel 57 and/or the return manifold 56 through the nozzles 38A, no air bubbles are generated in the head channel 57 and/or the return manifold 56. A time period during which the positive pressure pump 63 is driven is preset as a time period until the inspection liquid flows into all nozzles 38A and the gas in the liquid supply channel 61, the supply manifold 55, the head channel 57, the return manifold 56, and the liquid return channel 62 is discharged to the ink sub-tank 47.

The controller 130 moves the wiper 72 relative to the nozzle surface 50 of the head module 49 (step S13), after driving the positive pressure pump 63 for a predetermined time period. As a result, the nozzle surface 50 is wiped by the tip of the wiper 72. As the wiper 72 wipes the nozzle surface 50, the meniscuses of the inspection liquid are formed at the nozzles 38A. In addition, the inspection liquid adhering to the nozzle surface 50 is removed. The step S13 is an example of the third step. After the wiping (step S13), the purging process and/or the cap cleaning process may be executed.

The controller 130 drives the positive pressure pump 63 and the negative pressure pump 65 (step S14) after the wiping (S13). The controller 130 drives the positive pressure pump 63 to generate a second pressure value smaller than the first pressure value. The controller 130 controls the drive of the negative pressure pump 65 according to the pressure value detected by the pressure sensor 48. Normally, the absolute value of the negative pressure applied by the negative pressure pump 65 is greater than the absolute value of the positive pressure applied by the positive pressure pump 63 as much as, for example, about 1 kPa, in order to maintain the meniscuses of the liquid at the nozzles 38A. In other words, the absolute value of the positive pressure applied by the positive pressure pump 63 is smaller than the absolute value of the negative pressure applied by the negative pressure pump 65. This causes the inspection liquid to circulate between the ink sub-tank 47 and the head module 49 at the second pressure value. The step S14 is an example of the second step. Note that the controller 130 may be configured to execute the step S14 depending on acceptance of a second command indicating activation.

The initial introduction of the inspection liquid will be completed as described above. After the initial introduction has been completed, the inspection of the head module 49 will be executed by ejecting the ink droplets according to the image based on the test pattern data from the nozzles 38A while the inspection liquid is being circulated between the ink sub-tank 47 and the head module 49.

### (Initial Introduction of Ink (Second Initial Introduction Process))

In a case where a user uses the image recording apparatus 100 for the first time, the ink will be initially introduced into the head module 49. The supply manifold 55, the return manifold 56, the head channel 57, and the nozzles 38A of the head module 49 may be in a state in which no liquid exists, or the preservation liquid has been partially introduced for the purpose of preventing drying. Even in a case where the preservation liquid has been introduced, no meniscuses of the liquid are formed at the nozzles 38A on the nozzle surface 50. The maintenance unit 70 is located below the head module 49.

An ink tank 34 storing the ink will be installed in the installation case 110. Thereafter, a third command is sent to the controller 130 in a case where the initial introduction of the ink is selected and execution is entered on the operation panel 44.

In response to the acceptance of the third command (step S20), the controller 130 opens the ink supply valve 114 and drives the negative pressure pump 65 (step S21). This depressurizes the gas layer in the ink sub-tank 47, and the pressure difference between the pressure in the ink sub-tank 47 and the pressure in the ink tank 34 causes the ink in the ink tank 34 to be supplied to the ink sub-tank 47 through the ink tube 113. The negative pressure pump 65 is driven for a certain period of time to supply a predetermined amount of the ink from the ink tank 34 to the ink sub-tank 47. In a case where the supply of the ink has been completed, the ink supply valve 114 will be closed.

Next, the controller 130 drives the positive pressure pump 63 to generate the first pressure value (step S22). For example, the positive pressure applied to the liquid supply channel 61 by the positive pressure pump 63 is adjusted by controlling the number of the reciprocation per unit time and/or the distance of the reciprocation of the diaphragm of the diaphragm pump according to the pressure value detected by the pressure sensor 48. At this time, the controller 130 does not drive the negative pressure pump 65. The step S22 is an example of the fourth step.

The ink is introduced from the ink tank 34 to the ink sub-tank 47, by the drive of the positive pressure pump 63. Further, the ink is introduced from the ink sub-tank 47 to the supply manifold 55, the head channel 57, the return manifold 56, and the liquid return channel 62 through the liquid supply channel 61. With the introduction of the ink, gas in the supply manifold 55, the head channel 57, the return manifold 56, and the liquid return channel 62 is discharged through the liquid return channel 62 to the ink sub-tank 47.

Since the negative pressure pump 65 is not driven, no gas enters the head channel 57 and/or the return manifold 56 through the nozzles 38A, even in a state that no liquid exists in the nozzles 38A or no meniscuses are formed. Therefore, in a case where the head channel 57 is filled with the ink, the ink flows from the head channel 57 to the nozzles 38A. If meniscuses of the ink are not formed at the nozzles 38A, the ink flows out of the nozzles 38A, but the ink flown out of the nozzles 38A will be stored in the cap 71.

Since no gas enters the head channel 57 and/or the return manifold 56 through the nozzles 38A, no air bubbles are generated in the head channel 57 and/or the return manifold 56. A time period during which the positive pressure pump 63 is driven is preset as a time period until the ink flows into all nozzles 38A and the gas in the liquid supply channel 61, the supply manifold 55, the head channel 57, the return manifold 56, and the liquid return channel 62 is discharged to the ink sub-tank 47.

The controller 130 moves the wiper 72 relative to the nozzle surface 50 of the head module 49 (step S23), after driving the positive pressure pump 63 for a predetermined time period. As a result, the nozzle surface 50 is wiped by the tip of the wiper 72. As the wiper 72 wipes the nozzle surface 50, the meniscuses of the ink are formed at the nozzles 38A. In addition, the ink adhering to the nozzle surface 50 is removed. After the wiping, the purging process and/or the cap cleaning process may be executed.

Next, the controller 130 drives the positive pressure pump 63 and the negative pressure pump 65 (step S24). The controller 130 drives the positive pressure pump 63 to generate the second pressure value smaller than the first pressure value. The controller 130 controls the drive of the negative pressure pump 65 according to the pressure value detected by the pressure sensor 48. Normally, the absolute value of the negative pressure applied by the negative pressure pump 65 is greater than the absolute value of the positive pressure applied by the positive pressure pump 63 as much as, for example, about 1 kPa, in order to maintain the meniscuses of the liquid at the nozzles 38A. In other words, the absolute value of the positive pressure applied by the positive pressure pump 63 is smaller than the absolute value of the negative pressure applied by the negative pressure pump 65. This causes the ink to circulate between the ink sub-tank 47 and the head module 49 at the second pressure value. The step S24 is an example of the fifth step.

The ink is introduced from the ink tank 34 to the ink sub-tank 47 by driving the positive pressure pump 63 and the negative pressure pump 65. Further, the ink is introduced from the ink sub-tank 47 through the liquid supply channel 61 to the supply manifold 55, the head channel 57, the return manifold 56, and the liquid return channel 62. With the introduction of the ink, the gas in the supply manifold 55, the head channel 57, the return manifold 56, and the liquid return channel 62 is discharged to the ink sub-tank 47 through the liquid return channel 62.

In a case where the head channel 57 is filled with the ink, the ink flows from the head channel 57 to the nozzles 38A. If meniscuses of the ink are not formed at the nozzles 38A, the ink flows out of the nozzles 38A, but the ink flown out of the nozzles 38A will be stored in the cap 71. The initial introduction of the ink will be completed as described above. After the initial introduction has been completed, the image recording apparatus 100 is in a state in which the image recording apparatus 100 can perform normal image recording. (Effects of Embodiments)

In a case where the air bubbles are generated in the inspection liquid with the surface tension of 30 mN/m or greater, the air bubbles may adhere to the inner surface(s) of the head channel 57 and/or the return manifold 56, and even in a case where the inspection liquid flows in the head channel 57 and/or the return manifold 56, the air bubbles adhering to the inner surface(s) may not flow to the ink sub-tank 47. In the step S12 of the initial introduction of the inspection liquid, the negative pressure pump 65 is stopped and the positive pressure pump 63 is driven, and thus, the inspection liquid flows in order from the liquid supply channel 61 to the supply manifold 55, the head channel 57, the return manifold 56, and the liquid return channel 62, and the gas flows with the flow of the inspection liquid through the liquid return channel 62 and is discharged into the ink sub-tank 47. Since the negative pressure pump 65 is stopped in the step S12, no gas enters the head channel 57 from the nozzles 38A, and the air bubbles is less likely to be generated in the head channel 57. After the head channel 57, the return manifold 56, and the liquid return channel 62 are filled with the inspection liquid in the step S12, the positive pressure pump 63 and the negative pressure pump 65 are driven in the step S14, and thus the inspection liquid is circulated between the ink sub-tank 47 and the head module 49.

In the step S13, the meniscuses of the inspection liquid are formed at the nozzles 38A by the wiper 72 sliding on the nozzle surface 50. The formation of the meniscuses of the inspection liquid at the nozzles 38A reduces entrance of the gas into the head channel 57 from the nozzles 38A in the step S14.

Even in a case where the ink is initially introduced, since the negative pressure pump 65 is stopped in the step 22, no gas enters the head channel 57 from the nozzles 38A, and the air bubbles are less likely to be generated in the head channel 57. After the head channel 57, the return manifold 56, and the liquid return channel 62 are filled with the ink in the step S22, the positive pressure pump 63 and the negative pressure pump 65 are driven in the step S24, and thus the ink is circulated between the ink sub-tank 47 and the head module 49.

In the step S14 and the step S24, the absolute value of the positive pressure applied by the positive pressure pump 63 is smaller than the absolute value of the negative pressure applied by the negative pressure pump 65. Thus, the liquid has negative pressure in the head channel 57 and the meniscuses at the nozzles 38A are maintained.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above embodiments, the second pressure value of the positive pressure pump 63 in the step S14 is smaller than the first pressure value of the positive pressure pump 63 in the step S12. However, such aspect is not exclusive. The pressure values of the positive pressure pump 63 in the steps S12, S14 may be the same as each other, or the first pressure value may be smaller than the second pressure value.

The absolute value of the positive pressure applied by the positive pressure pump 63 in the step S14 and the step S24 may be the same as or approximately the same as the absolute value of the negative pressure applied by the negative pressure pump 65.

What is claimed is:

1. A liquid ejecting apparatus comprising:
a tank configured to store a liquid;
a head including:
a nozzle;
a head channel communicating with the nozzle;
a supply manifold communicating with the head channel; and
a return manifold communicating with the head channel;
a liquid supply channel connecting the tank and the supply manifold;
a liquid return channel connecting the tank and the return manifold;
a positive pressure pump configured to apply positive pressure to supply the liquid from the tank to the head through the liquid supply channel;
a negative pressure pump configured to apply negative pressure to discharge the liquid from the head to the tank through the liquid return channel; and
a controller configured to execute a first initial introduction process depending on acceptance of a first command indicating an initial introduction of a first liquid, wherein:
the first initial introduction process includes:
a first step of driving the positive pressure pump in a state that the negative pressure pump is stopped; and
a second step of driving the positive pressure pump and the negative pressure pump after the first step; and
surface tension of the first liquid stored in the tank in the first initial introduction process is 30 mN/m or greater.

2. The liquid ejecting apparatus according to claim 1 further comprising a wiper configured to move relative to a nozzle surface of the head, the nozzle opening at the nozzle surface,
wherein the first initial introduction process includes a third step of moving the wiper relative to the nozzle surface after the first step and before the second step.

3. The liquid ejecting apparatus according to claim 1, wherein:
the controller is configured to execute the second step depending on acceptance of a second command indicating activation; and
a first value of the positive pressure applied by the positive pressure pump in the first step is greater than a second value of the positive pressure applied by the positive pressure pump in the second step.

4. The liquid ejecting apparatus according to claim 3, wherein an absolute value of the positive pressure applied by the positive pressure pump in the second step is smaller than an absolute value of the negative pressure applied by the negative pressure pump in the second step.

5. The liquid ejecting apparatus according to claim 1, wherein:
the controller is configured to execute a second initial introduction process depending on acceptance of a third command instructing an initial introduction of a second liquid different from the first liquid;
the second initial introduction process includes:
a fourth step of driving the positive pressure pump in a state that the negative pressure pump is stopped; and
a fifth step of driving the positive pressure pump and the negative pressure pump after the fourth step; and
surface tension of the second liquid stored in the tank in the second initial introduction process is smaller than the surface tension of the first liquid.

6. A head inspection method in which a head is inspected by:
supplying an inspection liquid, having surface tension greater than surface tension of an ink to be ejected from a nozzle of the head in image recording, from a tank storing the inspection liquid to a head channel communicating with the nozzle, a supply manifold communicating with the head channel, and a return manifold communicating with the head channel through a liquid supply channel;
returning the inspection liquid to the tank through a liquid return channel from the return manifold; and
ejecting the inspection liquid from the head,
the head inspection method comprising:
a first step of applying a positive pressure to supply the inspection liquid from the tank to the head through the liquid supply channel by driving a positive pressure pump in a state that a negative pressure pump is stopped; and
a second step of applying a negative pressure to discharge the liquid from the head to the tank through the liquid return channel and the positive pressure, by driving the positive pressure pump and the negative pressure pump, after the first step.

7. The head inspection method according to claim 6, wherein the surface tension of the inspection liquid is 30 mN/m or greater.

8. The head inspection method according to claim 6 further comprising a third step of moving a wiper relative to a nozzle surface of the head, after the first step and before the second step.

9. The head inspection method according to claim 6, wherein a first value of the positive pressure applied by the positive pressure pump in the first step is greater than a second value of the positive pressure applied by the positive pressure pump in the second step.

10. The head inspection method according to claim 9, wherein an absolute value of the positive pressure applied by the positive pressure pump in the second step is smaller than an absolute value of the negative pressure applied by the negative pressure pump in the second step.
